(19) United States
(12) Patent Application Publication
(10) Pub. No.: US 2021/0138361 A1
(43) Pub. Date: May 13, 2021

(54) MATERIALS AND METHODS FOR MIXED MODE, ANION EXCHANGE REVERSED PHASE LIQUID CHROMATOGRAPHY

(71) Applicant: Waters Technologies Corporation, Milford, MA (US)

(72) Inventors: Matthew A. Lauber, North Smithfield, RI (US); Xiaoxiao Liu, Milford, MA (US); Qi Wang, Belmont, MA (US); Nicole Lawrence, Stafford Springs, CT (US)

(21) Appl. No.: 17/091,196

(22) Filed: Nov. 6, 2020

Related U.S. Application Data
(60) Provisional application No. 62/932,174, filed on Nov. 7, 2019.

(51) Int. Cl. B01D 15/36; B01J 20/283; B01J 20/28

(52) U.S. Cl. CPC B01D 15/363; B01J 20/283; B01D 2252/10; B01J 20/28085; B01J 2220/54; B01J 20/28083

(57) ABSTRACT

In various aspects, the present disclosure pertains to high purity chromatographic materials that comprise a chromatographic surface wherein the chromatographic surface comprises a hydrophobic modifier and an ionizable modifier comprising one or more anion exchange moieties that are positively charged when ionized, as well as devices containing such materials. In other aspects, the present disclosure provides methods for mixed mode, anion exchange reversed phase liquid chromatography comprising: (a) loading a sample comprising a plurality of acidic analytes (e.g., acidic glycans) onto a chromatographic separation device comprising such a high purity chromatographic material and (b) eluting adsorbed acidic analytes from the high purity chromatographic material with a mobile phase comprising water, organic solvent, and an organic acid salt, wherein during the course of elution a pH of the mobile phase, an ionic strength of the mobile phase, and a concentration of the organic solvent are altered over time.

### CROSS-REFERENCE TO RELATED APPLICATIONS

This application claims the benefit of and priority to U.S. Provisional Patent Application No. 62/932,174, filed on Nov. 7, 2019, the entire contents of which is hereby incorporated by reference.

### BACKGROUND

Glycans are found throughout biological systems in both a free state as well as in conjugated forms as parts of glycoproteins, glycolipids, and proteoglycans. Glycans play a role in a variety of biological and physiological processes.

Analysis by MS has reached a high degree of development with respect to glycan and amino acid analysis and proteomics. The current state of the art utilizes tagging molecules that react quickly and give good MS/fluorescence signals. Fluorescence detection is very useful tool in determining the relative quantities of different glycans. On the other hand, MS is used to determine molecular information. As a result, there is a desire to have both forms of detection. The labels of choice for state-of-art glycan detection have tended to be unique in having relatively high hydrophobicity paired with a high pKa ionizable residue, making them so-called ‘amphipathic, strongly basic’ moieties.

A continuing need exists for high purity chromatographic materials and corresponding separation methods that produce optimal selectivity and resolution for glycans, including glycans labeled with amphipathic, strongly basic moieties.

### SUMMARY

In various aspects, the present disclosure utilizes high purity chromatographic material that comprises a chromatographic surface wherein the chromatographic surface comprises a hydrophobic modifier and an ionizable modifier comprising one or more anion exchange moieties, which are positively charged when ionized. In addition, the high purity chromatographic material is hydrolytically stable over a pH range of about 3 to about 10, and beneficially is stable over a pH range of about 2 to about 12 in some embodiments.

In some embodiments, the high purity chromatographic material is an inorganic material, a hybrid organic/inorganic material, an inorganic material with a hybrid surface layer, a hybrid material with an inorganic surface layer, or a hybrid material with a different hybrid surface layer.

In various embodiments where the high purity chromatographic material comprises an inorganic material, the inorganic material may be selected from silica, alumina, titania, zirconia and combinations thereof, among others.

In various embodiments where the high purity chromatographic material comprises a hybrid organic/inorganic material, the material may comprise ≡Si—(CH₂)ₙ—Si moieties and/or ≡Si—O—(CH₂)ₘCH₃ moieties, where n is an integer equal to 1, 2, 3, or 4 and m is an integer equal to 0, 1, 2 or 3. One such material, which comprises both ≡Si—(CH₂)ₙ—Si≡ moieties and Si—O—(CH₂)ₘCH₃ moieties (and Et represents —CH₂CH₃) is shown schematically in the following formula I (where n represents a repeating structure):

[chemical structure]

In various embodiments, the high purity chromatographic material may be formed by hydrolytically condensing one or more silane compounds, which typically include (a) one or more silane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, although at most three of Z₁, Z₂, Z₃ and Z₄ can be C₁-C₄ alkyl, for example, tetraalkoxysilanes, including tetra-C₁-C₄-alkoxysilanes such as tetramethoxysilane, tetraethoxysilane, tetrachlorosilane, methyl-triethoxysilane, and methyl-trichlorosilane, among others, and alkyl-trialkoxysilanes, for example, C₁-C₄-alkyl-tri-C₁-C₄-alkoxysilanes, such as methyl triethoxysilane, methyl trimethoxysilane, or ethyl triethoxysilane, among others and/or (b) one or more compounds of the formula Si Z₁Z₂Z₃—R—SiZ₄Z₅Z₆, where Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl, and where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, and where R is an organic radical, for example, selected from C₁-C₁₈ alkylene, C₂-C₁₈ alkenylene, C₂-C₁₈ alkynylene or C₆-C₁₈ arylene groups, examples of which include bis(trialkoxysilyl)alkanes, typically, bis(tri-C₁-C₄-alkoxysilyl) C₁-C₄-alkanes such as bis(trimethoxysilyl)methane, bis(trimethoxysilyl)ethane, bis(triethoxysilyl)methane, bis(triethoxysilyl)ethane, among others.

Thus, in some embodiments, the high purity chromatographic material may be formed by hydrolytically condensing one or more organosilane compounds that comprise one or more alkoxysilane compounds. Examples of alkoxysilane compounds include, for instance, tetraalkoxysilanes (e.g., tetramethoxysilane (TMOS), tetraethoxysilane (TEOS), etc.), alkylalkoxysilanes such as alkyltrialkoxysilanes (e.g., methyl trimethoxysilane, methyl triethoxysilane (MTOS), ethyl triethoxysilane, etc.) and bis(trialkoxysilyl)alkanes (e.g., bis(trimethoxysilyl)methane, bis(trimethoxysilyl)ethane, bis(triethoxysilyl)methane, bis(triethoxysilyl)ethane (BTE), etc.), as well as combinations of the foregoing. In certain of these embodiments, the silica-based materials may be prepared from two alkoxysilane compounds: a tetraalkoxysilane such as TMOS or TEOS and an alkylalkoxysilane such as MTOS or a bis(trialkoxysilyl)alkane such as BTEE. When BTEE is employed as a monomer, the resulting materials are organic-inorganic hybrid materials, which are sometimes referred to as ethylene bridged hybrid (BEH) materials and can offer various advantages over conventional silica-based materials, including chemical and mechanical stability. Formula I above is a schematic representation of a BEH material, which can be formed from hydrolytic condensation of TEOS and B TEE.

As noted above, in the present disclosure, high purity chromatographic materials such as those described above, among others have a chromatographic surface wherein the chromatographic surface comprises a hydrophobic modifier and one or more anion exchange moieties, which are positively charged when ionized.

In some embodiments, the hydrophobic modifier comprises a hydrocarbon moiety having from 4 to 30 carbon atoms.

In some embodiments, the hydrophobic modifier comprises a C₄-C₃₀ aliphatic moiety (e.g., a linear, branched or cyclic C₄-C₃₀ alkyl moiety), C₄-C₃₀ aromatic moiety, a phenylalkyl (e.g., phenylhexyl, etc.) moiety, or a fluoro-aromatic (e.g., pentafluorophenylalkyl, etc.) moiety.

In some embodiments, the hydrophobic modifier comprises one or more alkyl groups, including linear, branched and cyclic alkyl groups that contain from 4 to 30 carbon atoms, typically, 8 to 18 carbon atoms.

In various embodiments, the chromatographic surface is derivatized by reacting the high purity chromatographic material with a reactive hydrophobic modifying reagent, for example, a reactive hydrophobic modifying reagent that comprises (a) a hydrophobic moiety and (b) one or more reactive silane groups.

In certain embodiments, the ionizable modifying reagent is of the formula M(SiZ₁Z₂Z₃), where n=1, 2, 3, or more, M designates a hydrophobic moiety, and Z₁, Z₂ and Z₃ are independently selected from Cl, Br, I, C₁-C₄ alkoxy and C₁-C₄ alkylamino. Examples of hydrophobic moieties include a hydrocarbon moiety having from 4 to 30 carbon atoms, a hydrocarbon moiety that comprises a C₄-C₃₀ aliphatic moiety, C₄-C₃₀ aromatic moiety, a phenylalkyl moiety, or a fluoro-aromatic moiety. In some embodiments, the hydrophobic modifier comprises one or more alkyl groups, including linear, branched and cyclic alkyl groups that contain from 4 to 30 carbon atoms, typically, 8 to 18 carbon atoms.

In certain embodiments, the ionizable modifying reagent may be a reactive organosilane such as a reactive C₄-C₃₀ organosilane selected from phenylhexyltrichlorosilane, pentafluorophenylpropyltrichlorosilane, octyltrichlorosilane, octadecyltrichlorosilane, octyldimethylchlorosilane and octadecyldimethylchlorosilane, among others.

In some embodiments, the hydrophobic modifier is present in a surface concentration ranging from 0.1 to 5 micromoles per square meter.

Turning to the ionizable modifier, in some embodiments, the ionizable modifier comprises an anion exchange moiety having a pKa ranging from 4 to 13.

In some embodiments, the ionizable modifier comprises an anion exchange moiety selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety that is attached to the chromatographic surface by one, two, three, four, five, six, seven, eight, nine, ten, eleven, twelve or more siloxy bonds and, in certain beneficial embodiments, is attached to the chromatographic surface by six or more siloxy bonds. For example, the ionizable modifier may be an amine-containing moiety that is attached to the chromatographic surface by six siloxy bonds, which can be formed from a bis(trialkoxysilyl) amine ionizable modifying reagent or may be an amine-containing moiety that is attached to the chromatographic surface by nine siloxy bonds, which can be formed from a tris[(trialkoxysilyl) amine ionizable modifying reagent, among many other options.

In various embodiments, the ionizable modifier comprises an anion exchange moiety selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety that bridges two or more siloxy groups, with each siloxy group being attached to the chromatographic surface by three siloxy bonds.

In some aspects of the present disclosure, the molar ratio of the hydrophobic modifier:ionizable modifier is from about 2:1 to about 100:1; from about 2.5:1 to about 67:1; from about 4:1 to about 35:1; from about 5:1 to about 25:1.

In other aspects, a surface concentration of ionizable modifier is from about 0.01 mol/m² to about 1.0 mol/m², from about 0.03 mol/m² to about 0.5 μmol/m², or from about 0.1 μmol/m² to about 0.3 μmol/m².

In various embodiments, the chromatographic surface may be derivatized by reacting the high purity chromatographic material with an ionizable modifying reagent. In various embodiments, the ionizable modifying reagent may comprise (a) one or more moieties selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety and (b) one or more reactive silane groups.

The amine-containing moiety may comprise, for example, one, two, three, four or more amino groups, for example, selected from primary amine groups, secondary amine groups, tertiary amine groups, and combinations thereof. Similarly, the guanidine-containing moiety, the amidine-containing moiety, the pyridyl-containing moiety, the imidazolyl-containing moiety, the carbazolyl-containing moiety, the isocyanurate-containing moiety or the semicarbazidyl-containing moiety may contain one, two, three, or more guanidine groups, amidine groups, pyridyl groups, imidazolyl groups, carbazolyl groups, an isocyanurate groups, or semicarbazidyl groups, respectively.

The reactive silane groups may contain one, two, or three reactive groups, typically, three reactive groups, which may be selected, for example, from Cl, Br, I, C₁-C₄ alkoxy, and C₁-C₄ alkylamino.

In certain embodiments, the ionizable modifying reagent is of the formula A(SiZ₁Z₂Z₃)ₙ where n=1, 2, 3, 4 or more, A designates an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety, and Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl and, in various embodiments, none of Z₁, Z₂ and Z₃ are C₁-C₄ alkyl (in other words, Z₁, Z₂ and Z₃ are independently selected from Cl, Br, I, C₁-C₄ alkoxy, and C₁-C₄ alkylamino). When n=2 or more, each of the —SiZ₁Z₂Z₃ groups may be the same as each other, or each of the —SiZ₁Z₂Z₃ groups may be different from one another.

In certain embodiments, the ionizable modifying reagent is selected from bis- and tris-silyl ionizable modifiers.

Specific ionizable modifying reagents of the formula of the formula A(SiZ₁Z₂Z₃), may be selected from one or more of the following, among others: N-(2-aminoethyl)-11-aminoundecyltrimethoxysilane

[chemical structure]

(n=1, A is an amine-containing moiety, Z₁, Z₂ and Z₃ are C₁-C₄ alkoxy); methanamine, 1-(triethoxysilyl)-N,N-bis[(triethoxysilyl)methyl]-

[chemical structure]

n=3, A is an amine-containing moiety, Z₁, Z₂ and Z₃ are C₁-C₄ alkoxy); 1-butanamine, 2,2-dimethyl-4-(trimethoxysilyl)

[chemical structure]

(n=1, A is an amine-containing moiety, Z₁, Z₂ and Z₃ are C₁-C₄ alkoxy); 1-propanamine, N-methyl-3-(trimethoxysilyl)-N-[3-(trimethoxysilyl)propyl]-

[chemical structure]

(n=2, A is an amine-containing moiety, Z₁, Z₂ and Z₃ are C₁-C₄ alkoxy); 1-hexanamine, N,N-dimethyl-6-(trimethoxysilyl)-

[chemical structure]

(n=1, A is an amine-containing moiety, Z₁, Z₂ and Z₃ are C₁-C₄ alkoxy); ethanol, 2-[bis[3-(trimethoxysilyl) propyl]amino]-

[chemical structure]

(n=2, A is an amine-containing moiety, Z₁, Z₂ and Z₃ are C₁-C₄ alkoxy); 2-oxa-7,10-diaza-3-siladodecan-12-ol, 7-(2-hydroxyethyl)-3,3-dimethoxy-10-[3-(trimethoxysilyl)propyl]

[chemical structure]

(n=2, A is an amine-containing moiety, Z₁, Z₂ and Z₃ are C₁-C₄ alkoxy); 1-butanamine, 4-(diethoxvethylsilyl)-N-[4-(diethoxyethylsilyl)butyl]-

[chemical structure]

(n=2, A is an amine-containing moiety, Z₁, Z₂ and Z₃ are C₁-C₄ alkoxy); 11-aminoundecyltriethoxysilane

[chemical structure]

(n=1, A is an amine-containing moiety, Z₁, Z₂ and Z₃ are C₁-C₄ alkoxy); 4-aminobutyltriethoxysilane

[chemical structure]

(n=1, A is an amine-containing moiety, Z₁, Z₂ and Z₃ are C₁-C₄ alkoxy); 1,2-ethanediamine, N¹,NF²-bis[(diethoxymethylsilyl)methyl]-N¹,N²-dimethyl-

[chemical structure]

(n=2, A is an amine-containing moiety, Z₁, Z₂ and Z₃ are C₁-C₄ alkoxy); 1,2-ethanediamine, N¹-(3-phenyl-2-propen-1-yl)-N¹-[3-(trimethoxysilyl)propyl]-

[chemical structure]

(n=1, A is an amine-containing moiety, Z₁, Z₂ and Z₃ are C₁-C₄ alkoxy); 1-propanamine, N-ethyl-2-methyl-1-(trimethoxysilyl)-

[chemical structure]

(n=1, A is an amine-containing moiety, Z₁, Z₂ and Z₃ are C₁-C₄ alkoxy); 1-naphthalenamine, N,N-dimethyl-4-(triethoxysilyl)-

[chemical structure]

(n=1, A is an amine-containing moiety, Z₁, Z₂ and Z₃ are C₁-C₄ alkoxy); 9H-carbazole, 9-[2-(triethoxysilyl)ethyl]-

[chemical structure]

(n=1, A is an carbazolyl-containing moiety, Z₁, Z₂ and Z₃ are C₁-C₄ alkoxy); 1,2-ethanediamine, N¹,N¹,N²-trimethyl-N²-[3-(trimethoxysilyl)propyl]-

[chemical structure]

(n=1, A is an amine-containing moiety, Z₁, Z₂ and Z₃ are C₁-C₄ alkoxy); aminoethylaminomethyl)phenethyltrimethoxysilane

[chemical structure]

(n=1, A is an amine-containing moiety, Z₁, Z₂ and Z₃ are C₁-C₄ alkoxy); 1,3,5-triazine-2,4,6(1H,3H,5H)-trione, 1,3,5-tris[3-(trimethoxysilyl) propyl]-

[chemical structure]

n=3, A is an isocyanurate-containing moiety, Z₁, Z₂ and Z₃ are C₁-C₄ alkoxy); 1-propanamine, 3-(triethoxysilyl)-N-[3-(triethoxy silyl)propyl]-

[chemical structure]

(n=2, A is an amine-containing moiety, Z₁, Z₂ and Z₃ are C₁-C₄ alkoxy); 1,2-ethanediamine, N¹,N¹-bis[3-(dimethoxymethylsilyl)propyl]-

[chemical structure]

(n=2, A is an amine-containing moiety, Z₁, Z₂ and Z₃ are C₁-C₄ alkoxy); 1,2-ethanediamine, N¹,N²-bis[3-(trimethoxysilyl)propyl]-

[chemical structure]

(n=2, A is an amine-containing moiety, Z₁, Z₂ and Z₃ are C₁-C₄ alkoxy); 3,3,15,15-tetramethoxy-2,7,16-trioxa-11-aza-3,15-disilaheptadecan-9-ol

[chemical structure]

(n=2, A is an amine-containing moiety, Z₁, Z₂ and Z₃ are C₁-C₄ alkoxy); 3-(m-aminophenoxy)propyltrimethoxysilane

[chemical structure]

(n=1, A is an amine-containing moiety, Z₁, Z₂ and Z₃ are C₁-C₄ alkoxy); 3-(4-semicarbazidyl)propyltriethoxysilane

[chemical structure]

(n=1, A is a semicarbazidyl-containing moiety, Z₁, Z₂ and Z₃ are C₁-C₄ alkoxy); (17-aminoheptadecyl)trimethoxysilane

[chemical structure]

(n=1, A is an amine-containing moiety, Z₁, Z₂ and Z₃ are C₁-C₄ alkoxy); 16-aminohexadecyltrimethoxysilane

[chemical structure]

(n=1, A is an amine-containing moiety, Z₁, Z₂ and Z₃ are C₁-C₄ alkoxy); N¹-[12-(triethoxysilyl)dodecyl]-1,2-ethanediamine

[chemical structure]

(n=1, A is an amine-containing moiety, Z₁, Z₂ and Z₃ are C₁-C₄ alkoxy); 1,7-heptanediamine, N1,N7-bis[9-(triethoxysilyl)nonyl]-

[chemical structure]

(n=2, A is an amine-containing moiety, Z₁, Z₂ and Z₃ are C₁-C₄ alkoxy); 1,7-Heptanediamine, N1,N1-bis[7-(trimethoxysilyl)heptyl]-

[chemical structure]

(n=2, A is an amine-containing moiety, Z₁, Z₂ and Z₃ are C₁-C₄ alkoxy); 1,10-decanediamine, N1,N10-bis[6-(dimethoxymethylsilyl)hexyl]-N1,N10-dimethyl-

[chemical structure]

(n=2, A is an amine-containing moiety, Z₁, Z₂ and Z₃ are C₁-C₄ alkoxy); 1,2-ethanediamine, N2-[3-(trimethoxysilyl)propyl]-N1,N1-bis[2-[[3-(trimethoxysilyl)propyl]amino]ethyl]-

[chemical structure]

(n=3, A is an amine-containing moiety, Z₁, Z₂ and Z₃ are C₁-C₄ alkoxy); 1,2-ethanediamine, N,N,N′-tris[3-(trimethoxysilyl)propyl]-

[chemical structure]

(n=3, A is an amine-containing moiety, Z₁, Z₂ and Z₃ are C₁-C₄ alkoxy); 1-octadecanamine, N-[3-(trimethoxysilyl)propyl]-

[chemical structure]

(n=1, A is an amine-containing moiety, Z₁, Z₂ and Z₃ are C₁-C₄ alkoxy); 1-docosanamine, N43-(trimethoxysilyl)propyl]-

[chemical structure]

(n=1, A is an amine-containing moiety, Z₁, Z₂ and Z₃ are C₁-C₄ alkoxy); and 1,3-propanediamine, N-octadecyl-N′-[3-(trimethoxysilyl)propyl]-

[chemical structure]

(n=1, A is an amine-containing moiety, Z₁, Z₂ and Z₃ are C₁-C₄ alkoxy).

Further ionizable modifying reagents may be selected from one or more of the following, among others: 1-propanamine, 3-(dimethoxyphenylsilyl)-; 3-aminopropyldiisopropylethoxysilane; N-cyclohexylaminomethyltriethoxysilane; 2-(4-pyridylethyl)triethoxysilane; N,N-diethylaminopropyl)trimethoxysilane; 3-aminopropyl)triethoxysilane; N-3-[(amino(polypropylenoxy)]aminopropyltrimethoxysilane; N,N′-bis(2-hydroxyethyl)-N,N′-bis(trimethoxysilylpropyl)ethylenediamine; N-(2-aminoethyl)-3-aminopropyltrimethoxysilane; N-cyclohexyl-3-aminopropyltrimethoxysilane; N-(2-aminoethyl)-3-aminopropylmethyldimethoxysilane 3-octadecanamine, 1-(trimethoxysilyl)-; 1-hexadecanamine, N,N-bis[3-(trimethoxysilyl)propyl]-; and 3,8-dioxa-4,7-disiladecan-5-amine, 4,4,7,7-tetraethoxy-N-hexadecyl-N-propyl.

It is further noted that certain ionizable modifying reagents, in addition to providing a chromatographic surface with an ionizable modifier comprising one or more anion exchange moieties as described herein, may also at the same time provide the chromatographic surface with a hydrophobic modifier as described herein. Examples of such ionizable modifying reagents include 1-octadecanamine, N-[3-(trimethoxysilyl) propyl]-; 1-docosanamine, N-[3-(trimethoxysilyl)propyl]-; 1,3-ropanediamine, N-octadecyl-N′-[3-(trimethoxysilyl)propyl]-; 3-octadecanamine, 1-(trimethoxysilyl)-; 1-hexadecanamine, N,N-bis[3-(trimethoxysilyl)propyl]-; 3,8-Dioxa-4,7-disiladecan-5-amine, 4,4,7,7-tetraethoxy-N-hexadecyl-N-propyl. In these embodiments, the ionizable modifier may be used in combination with an additional hydrophobic modifying reagent as descried herein or may be used independent of such an additional hydrophobic modifying reagent.

In various embodiments, after the chromatographic surface has been provided with an ionizable modifier and a hydrophobic modifier, the surface may be further treated to remove any excess silanol groups and to provide the surface with additional organic character by reacting the surface with a silane capping reagent. Examples of such silane capping reagents include one or more silane compounds of the formula SiZ₁Z₂Z₃Z₄, where Z₁ is selected from Cl, Br, I, C₁-C₄ alkoxy and C₁-C₄ alkylamino and wherein Z₂, Z₃ Z₄ are independently selected from and C₁-C₂ alkyl. Specific examples of such silane capping reagents include triethylchlorosilane, trimethylchlorosilane, (N,N dimethylamino)triethylsilane, and (N,N dimethylamino)trimethylsilane, among others.

In certain aspects, the high purity chromatographic material of the present disclosure may be in the form of a particle, a monolith, a superficially porous material, a superficially porous particle, a superficially porous monolith, or a superficially porous layer for open tubular chromatography, among other possible formats.

When the high purity chromatographic material is in the form of a particle, the high purity chromatographic material may have an average particle size of about 0.3-100 μm; about 0.5-20 μm; 0.8-10 μm; or about 1.0-5.0 μm.

In some embodiments, the high purity chromatographic material may have average pore diameter of about 20 to 1500 Å; about 50 to 1000 Å; about 60 to 500 Å; or about 75 to 300 Å.

In certain aspects, the high purity chromatographic material of the present disclosure may be in the form of a monolith having a core material or a particle having a core material. The core material may be selected, for example, from organic materials, inorganic materials, or organic-inorganic hybrid materials.

In certain aspects, the present disclosure provides chromatographic separation devices that contain high purity chromatographic materials such as those described above. Examples of such devices include, for example, chromatographic columns, thin layer plates, a filtration membranes, microfluidic separation devices, sample cleanup devices, solid supports, solid phase extraction devices, microchip separation devices, and microtiter plates.

In certain aspects, the present disclosure provides chromatographic columns that contain high purity chromatographic materials such as those described above, wherein an interior surface of the column is formed of an inert material.

In some embodiments, the column may be a non-metallic column formed of an inert material, for example, a polymeric material such as PEEK or PTFE or PFA.

In some embodiments, the column may be a metallic column that is coated with an inert material.

Examples of such inert coating materials may be selected from polymer coatings, alkylsilyl coatings, and inorganic coatings derived from chemical vapor deposition. Polymer coatings may be formed, for example, from polyetheretherketone (PEEK). Alkylsilyl coatings include alkylsilyl coatings having the Formula II:

[chemical structure]

where R¹, R², R³, R⁴, R⁵, and R⁶ are each independently selected from (C₁-C₆)alkoxy, NH(C₁-C₆)alkyl, —N((C₁-C₆)alkyl)₂, OH, OR^{A}, and halo, where R^{A} represents a point of attachment to the interior surface of the column, and at least one of R¹, R², R³, R⁴, R⁵, and R⁶ is OR^{A}, and wherein X is (C₁-C₂₀)alkyl, —O[(CH₂)₂O]₁₋₂₀—, —(C₁-C₁₀)[NH(CO)NH(C₁-C₁₀)]₁₋₂₀—, or —(C₁-C₁₀)[alkylphenyl(C₁-C₁₀)alkyl]₁₋₂₀-. These and other materials are described in U.S. Patent Pub. No. 20190086371.

In certain aspects, the present disclosure provides methods that employ high purity chromatographic materials such as those described above.

In certain aspects, the present disclosure provides a method for mixed mode, anion exchange reversed phase liquid chromatography comprising: (a) loading a sample comprising a plurality of acidic analytes onto a chromatographic separation device comprising a high purity chromatographic material like that described above such that the acidic analytes are adsorbed onto the high purity chromatographic material; and (b) eluting the adsorbed acidic analytes from the high purity chromatographic material with a mobile phase comprising water, organic solvent, and an organic acid salt thereby separating the acidic analytes, wherein eluting the acidic analytes from the chromatography material with the mobile phase comprises a course of elution in which a pH of the mobile phase is altered over time, an ionic strength of the mobile phase is altered over time, and a concentration of the organic solvent is altered over time.

In various embodiments, the sample fluid is or is derived from a biological sample. Exemplary biological samples include biological fluids (e.g., whole blood samples, blood plasma samples, serum samples, oral fluids, urine, etc.), biological tissues, biological matrices, cells (e.g., one or more types of cells), cell culture supernatants, foods (e.g., meats, whole grains, legumes, eggs, etc.), and food extracts.

In some embodiments, the acidic analytes are acidic saccharides.

In some embodiments, the acidic analytes are acidic glycans. Acidic glycans may include sialylated glycans, phosphorylated glycans and sulfated glycans. Such glycan species can be analyzed in the form of released and labeled glycans, unlabeled native glycans, unlabeled reduced glycans, or glycopeptides.

In some embodiments, the organic solvent comprises one or more of methanol, ethanol, 1-propanol, 2-propanol, acetonitrile, acetone, ethyl acetate, methyl ethyl ketone, and tetrahydrofuran.

In some embodiments, the organic acid salt is a volatile organic acid salt that comprises an organic acid anion and a cation selected from an ammonium cation or an amine cation. Examples of organic acid anions include, for example, formate, difluoroacetate, trifluoroacetate, acetate, propionate, butyrate, oxalate, malonate, succinate, maleate, glutarate, glycolate, lactate, tartarate, malate, citrate and gluconate, among others.

In some embodiments, the mobile phase further comprises an organic acid.

Examples of organic acids include formic acid, difluoroacetic acid, trifluoroacetic acid, acetic acid, propionic acid, butyric acid, oxalic acid, malonic acid, succinic acid, maleic acid, glutaric acid, and organic hydroxyacids such as glycolic acid, lactic acid, tartaric acid, malic acid, citric acid and gluconic acid, among others.

In particular embodiments, the mobile phase comprises formic acid and ammonium formate.

In various embodiments, eluting the acidic analytes from the chromatographic material with the mobile phase comprises a course of elution in which a pH of the mobile phase is increased over time, in which an ionic strength of the mobile phase is increased over time, and in which and a concentration of the organic solvent is increased over time.

In some embodiments, the pH of the mobile phase increases over a range of at least 3 to 10 during the course of elution, in some embodiments, at least 2 to 12.

In some embodiments, the pH of the mobile phase increases by at least 2 units during the course of elution, in some embodiments, by at least 4 units, by at least 6 units, by at least 8 units, by at least 10 units, or more. In some embodiments, certain solvent gradients may be selected to specifically affect the activity coefficient and effective pKas of buffering reagents.

In some embodiments, the ionic strength of the mobile phase increases from 3 mmol to 20 mmol during the course of elution. In other embodiments, the ionic strength of the mobile phase may change from effectively zero to 200 mmol.

In some embodiments, at least two solutions are mixed to form the mobile phase. In some embodiments two solutions are mixed to form the mobile phase, a first of which is water and a second of which is a solution that comprises water, an organic solvent, an organic acid salt, and optionally, an organic acid.

In some embodiments, the method further comprises reacting a sample comprising the plurality of acidic analytes with a labeling reagent to produce a labeled analyte sample, loading the labeled analyte sample onto the chromatographic separation device, and eluting the adsorbed labeled analytes from the high purity chromatographic material with the mobile phase.

The labeling reagent may be selected from an MS active, fluorescent tagging, examples of which include a procainamide reagent, or a procaine reagent. The labeling reagent may be an amphipathic, strongly basic moiety having a Log P value between 0 and 5, typically between 1 and 5, more typically between 1 and 3. The labeling reagent may be an amphipathic, strongly basic moiety having a pKa value greater than 6, typically having a pKa value greater than 7, more typically having a pKa value greater than 8.

In particular embodiments, the labeling reagent is a reagent having the formula:

[chemical structure]

In other embodiments, the glycan labeling reagent may be 2-AA (Anthranilic acid), 3-ASA (aniline sulfonic acid), APTS (8-aminopyrene-1,3,6-trisulfonic acid), Gly-Q (Prozyme, San Leandro, Calif.) or derivatives and isomers thereof.

In some embodiments, the method further comprises subjecting the eluent from the liquid chromatography to mass spectrometry (MS), examples of which include tandem mass spectrometry (MS/MS), electrospray ionization mass spectrometry (ESI-MS), matrix-assisted laser desorption/ionization mass spectrometry (MALDI-MS), and time-of-flight mass spectrometry (TOFMS).

### BRIEF DESCRIPTION OF THE DRAWINGS

FIG. 1 is a chromatogram showing the results of anion exchange reversed phase liquid chromatography of fetuin N-glycans. The chromatogram is the result of 2.1×150 mm column packed with a 1.7 μm 100 Å high purity chromatographic material using the methods described in Example 9.

FIG. 2 is a chromatogram showing the results of anion exchange reversed phase liquid chromatography of RapiFluor-MS® labeled N-glycans from glucuronidase, illustrating separation of glucuronidase N-glycans The chromatogram is a result of a 2.1×150 mm column packed with a 1.7 μm 100 Å high purity chromatographic material using the methods described in Example 10.

### DETAILED DESCRIPTION

In specific embodiments, the present disclosure provides a method for mixed mode, anion exchange reversed phase liquid chromatography and the selective retention of acidic glycan species, including but not limited to sialylated, phosphorylated and sulfated glycans. These glycan species can be analyzed in the form of released and labeled derivatives, unlabeled native glycans, unlabeled, reduced glycans, or glycopeptides. The method advantageously combines volatile mobile phases with gradients of increasing concentrations of ammonium salt and organic solvent and columns packed with high purity chromatographic materials that are designed to minimize interference during electrospray ionization.

The present disclosure highlights the utility of materials prepared with ionizable modifying reagents having two, three or more silyl groups, including bis and tris silyl ionizable modifying reagents.

By selecting suitable ionizable modifiers, a surface chemistry can be created that is ideally suited to separating acidic glycans derivatized with MS-enhancing labels, including but not limited to amphiphilic, strongly basic moieties such as Waters RapiFluor-MS®, Prozyme Instant Procaine (InstantPC™), procaine, and procainamide. Ionizable modifiers described herein uniquely provide deeply embedded ionizable surface residues and thus show enhanced chromatographic selectivity. Because these ionizable modifiers have multiple points of attachment to their substrate, their corresponding high purity chromatographic materials exhibit comparatively low levels of so-called column bleed, which is of benefit to online mass spectrometric detection.

In various preferred embodiments, the present disclosure provides an LC-MS method for glycan profiling that achieves enhanced chromatographic resolving power with high sensitivity detection, as enabled by improved chromatographic materials that provide low levels of interference when used with mass spectrometric detection.

### Example 1

BEH porous hybrid particles (prepared following the method as described in U.S. Pat. No. 6,686,035) were fully dispersed in toluene (5 mL/g), then azeotropically stripped (reflux, 1 h) to ensure anhydrous conditions. An ionizable modifying reagent as shown in Table 1, S1-S10 (0.1-0.3 mol/m²) was added to the BEH/toluene slurry, then stirred at room temperature for 1 h.

TABLE 1

| Designation | Silane Name |
|---|---|
| S1 | 3-Aminopropyldiisopropylethoxysilane |
| S2 | N-(2-aminoethyl)-11-aminoundecyltrimethoxysilane |
| S3 | Methanamine, 1-(triethoxysilyl)-N,N-bis[(triethoxysilyl)methyl]- |
| S4 | N-Cyclohexylaminomethyltriethoxysilane |
| S5 | 2-(4-Pyridylethyl)triethoxysilane |
| S6 | 1-Butanamine, 2,2-dimethyl-4-(trimethoxysilyl) |
| S7 | 1-Propanamine, N-methyl-3-(trimethoxysilyl)-N-[3-(trimethoxysilyl)propyl]- |
| S8 | 1-Hexanamine, N,N-dimethyl-6-(trimethoxysilyl)- |
| S9 | Ethanol, 2-[bis[3-(trimethoxysilyl)propyl]amino]- |
| S10 | 2-Oxa-7,10-diaza-3-siladodecan-12-ol, 7-(2-hydroxyethyl)-3,3-dimethoxy-10- |
| | [3-(trimethoxysilyl)propyl] |

The slurry was then allowed to stir at reflux for 2 h under an inert atmosphere. The reaction was then cooled to room temperature and the particles were isolated via filtration. The particles were washed successively with toluene, acetone/water (1:1 v/v), and acetone. The isolated particles were then dried for 16 h at 80° C. under 25 mm vacuum. Once dry, the particles were fully dispersed in toluene (10 mL/g), then azeotropically stripped (reflux, 3 h) to ensure anhydrous conditions. A base catalyst (pyridine or imidazole: 3.2 mol/m²) was added to the particles/toluene slurry, then a hydrophobic modifying reagent (octadecyltrichlorosilane (tC₁₈): 1.6 mol/m²) was added to the particles/toluene slurry. The slurry was stirred at reflux for 20 h under an inert atmosphere. The reaction was cooled to room temperature and the particles were isolated via filtration. The particles were washed successively with toluene, acetone acetone/water (1:1 v/v), and acetone. The acetone-wet particles were transferred into a clean reactor, dispersed in acetone/0.12 M ammonium acetate (8.2:1.8 v/v) and hydrolyzed (59° C., 2 h). The particles were then isolated via filtration and washed successively with toluene, acetone, acetone/water (1:1 v/v), and acetone. Finally, the isolated surface modified particles were dried for 16 h at 70° C. under 25 mm vacuum and characterized. Results are shown in Table 2.

TABLE 2

| | | | | | | | Ionizable | |
|---|---|---|---|---|---|---|---|---|
| | | Ionizable Modifier (I) | | Hydrophobic Group (H) | | Charge | Modifier | Final Total |
| | Particles | Designated | Charge | | Charge | Molar | Coverage | Coverage |
| Product | (g) | Name | (μmol/m²) | Type | (μmol/m²) | Ratio H/I | (μmol/m²) | (μmol/m²) |
| 1a | 10 | S1 | 0.3 | tC18 | 1.61 | 5.4 | 0.24 | 2.00 |
| 1b | 10 | S2 | 0.3 | tC18 | 1.60 | 5.3 | 0.24 | 1.96 |
| 1c | 10 | S3 | 0.3 | tC18 | 1.60 | 5.3 | 0.24 | 1.65 |
| 1d | 10 | S4 | 0.3 | tC18 | 1.59 | 5.3 | 0.16 | 1.62 |
| 1e | 10 | S5 | 0.3 | tC18 | 1.60 | 5.3 | 0.04 | 1.69 |
| 1f | 10 | S6 | 0.3 | tC18 | 1.61 | 5.4 | 0.20 | 1.73 |
| 1g | 20 | S7 | 0.3 | tC18 | 1.60 | 5.3 | 0.28 | 1.71 |
| 1h | 10 | S7 | 0.2 | tC18 | 1.60 | 8.0 | 0.20 | 1.71 |
| 1i | 10 | S7 | 0.1 | tC18 | 1.60 | 16.0 | 0.08 | 1.66 |
| 1j | 10 | S8 | 0.3 | tC18 | 1.60 | 5.3 | 0.24 | 1.88 |
| 1k | 10 | S9 | 0.3 | tC18 | 1.60 | 5.3 | 0.28 | 1.82 |
| 1l | 10 | S10 | 0.3 | tC18 | 1.60 | 5.3 | 0.26 | 1.85 |

The surface coverage of ionizable modifier was determined by the difference in particle % N after surface modification as measured by elemental analysis. The surface coverage of the C₁₈ hydrophobic modifier was determined by the difference in particle % C before and after the surface modification as measured by elemental analysis. % N values were measured by combustion analysis (CE-440 Elemental Analyzer; Exeter Analytical Inc., North Chelmsford, Mass.) or % C by Coulometric Carbon Analyzer (modules CM5300, CM5014, UIC Inc., Joliet, Ill.).

### Example 2

Surface modified particles from Example 1 were fully dispersed in toluene (10 mL/g) and then azeotropically stripped (reflux, 1 h) to ensure anhydrous conditions. Triethylchlorosilane (TES) or (N,N-dimethylamino)triethylsilane was charged (TES: 5 mol/m²) to the surface modified particles/toluene slurry, then stirred at reflux for 4 h under an inert atmosphere. The reaction was then cooled to room temperature and trimethylchlorosilane or (N,N-dimethylamino)trimethylsilane was charged (TMS: 8 mol/m²) to the surface modified particles/toluene slurry, then stirred at reflux for 16 h under an inert atmosphere. A base catalyst (pyridine or imidazole: 3.2 mol/m²) was added to the reaction slurry if chlorosilanes were used. The reaction was cooled to room temperature and the particles were subsequently isolated via filtration and washed successively with toluene, acetone, acetone/water (1:1 v/v), and acetone. Finally, the isolated surface modified particles were dried for 16 h at 70° C. under 25 mm vacuum. Particles were characterized and the results presented in Table 3.

TABLE 3

| | Particles | | TES | TMS | Final Carbon |
|---|---|---|---|---|---|
| Product | (g) | Precursor | Mass (g) | Mass (g) | (% C) |
| 2a | 8 | 1a | 1.2 | 1.3 | 14.40 |
| 2b | 8 | 1b | 1.1 | 1.3 | 14.47 |
| 2c | 8 | 1c | 1.1 | 1.3 | 13.63 |
| 2d | 8 | 1d | 1.1 | 1.3 | 13.65 |
| 2e | 8 | 1e | 1.1 | 1.3 | 13.79 |
| 2f | 8 | 1f | 1.1 | 1.3 | 13.85 |
| 2g | 19 | 1g | 2.6 | 2.9 | 13.84 |
| 6h | 8 | 1h | 1.1 | 1.3 | 13.77 |
| 6i | 8 | 1i | 1.1 | 1.2 | 13.77 |
| 2j | 8 | 1j | 1.1 | 1.3 | 14.19 |
| 2k | 8 | 1k | 1.1 | 1.3 | 14.08 |
| 2l | 8 | 1l | 1.1 | 1.3 | 14.13 |

### Example 3

The method as described in Example 1 is expanded to include an ionizable modifier coverage of 0.03-1.0 μmol/m² and a hydrophobic modifier to ionizable modifier ratio of 2.5:1 to 67:1.

### Example 4

The surface modified particles from Example 3 are further modified using the method as described in Example 2.

### Example 5

The methods as described in Examples 1 and 3 are expanded to include other ionizable modifiers of interest, such as, but not limited to S11-S42 in Table 4 in combination with a hydrophobic group to yield a hydrophobic phase to ionizable modifier ratio of 2.5:1 to 67:1.

TABLE 4

| Designation | Silane Name |
|---|---|
| S11 | 11-Aminoundecyltriethoxysilane |
| S12 | 4-Aminobutyltriethoxysilane |
| S13 | 1,2-Ethanediamine, N¹,N²-bis[(diethoxymethylsilyl)methyl]-N¹,N²-dimethyl- |
| S14 | (N,N-Diethylaminopropyl)trimethoxysilane |
| S15 | (3-Aminopropyl)triethoxysilane |
| S16 | 1,2-Ethanediamine, N¹-(3-phenyl-2-propen-1-yl)-N¹-[3-(trimethoxysilyl)propyl]- |
| S17 | 1-Propanamine, 3-(dimethoxyphenylsilyl)- |
| S18 | 1-Propanamine, N-ethyl-2-methyl-1-(trimethoxysilyl)- |
| S19 | 1-Naphthalenamine, N,N-dimethyl-4-(triethoxysilyl)- |
| S20 | 9H-Carbazole, 9-[2-(triethoxysilyl)ethyl]- |
| S21 | 1,2-Ethanediamine, N¹,N¹,N²-trimethyl-N²-[3-(trimethoxysilyl)propyl]- |
| S22 | (Aminoethylaminomethyl)phenethyltrimethoxysilane |
| S23 | N-3-[(Amino(polypropylenoxy)]aminopropyltrimethoxysilane |
| S24 | 1,3,5-Triazine-2,4,6(1H,3H,5H)-trione, 1,3,5-tris[3-(trimethoxysilyl)propyl]- |
| S25 | 1-Propanamine, 3-(triethoxysilyl)-N-[3-(triethoxysilyl)propyl]- |
| S26 | 1,2-Ethanediamine, N¹,N¹-bis[3-(dimethoxymethylsilyl)propyl]- |
| S27 | 1,2-Ethanediamine, N¹,N²-bis[3-(trimethoxysilyl)propyl]- |
| S28 | N,N'-bis(2-hydroxyethyl)-N,N′-bis(trimethoxysilylpropyl)ethylenediamine |
| S29 | N-(2-Aminoethyl)-3-aminopropyltrimethoxysilane |
| S30 | N-Cyclohexyl-3-aminopropyltrimethoxysilane |
| S31 | N-(2-Aminoethyl)-3-Aminopropylmethyldimethoxysilane |
| S32 | 3,3,15,15-Tetramethoxy-2,7,16-trioxa-11-aza-3,15-disilaheptadecan-9-ol |
| S33 | 3-(m-Aminophenoxy)propyltrimethoxysilane |
| S34 | 3-(4-Semicarbazidyl)propyltriethoxysilane |
| S35 | (17-Aminoheptadecyl)trimethoxysilane |
| S36 | 16-Aminohexadecyltrimethoxysilane |
| S37 | N¹-[12-(Triethoxysilyl)dodecyl]-1,2-ethanediamine |
| S38 | 1,7-Heptanediamine, N1,N7-bis[9-(triethoxysilyl)nonyl]- |
| S39 | 1,7-Heptanediamine, N1,N1-bis[7-(trimethoxysilyl)heptyl]- |
| S40 | 1,10-Decanediamine, N1,N10-bis[6-(dimethoxymethylsilyl)hexyl]-N1,N10-dimethyl- |
| S41 | 1,2-Ethanediamine, N2-[3-(trimethoxysilyl)propyl]-N1,N1-bis[2-[[3-(trimethoxysilyl) |
| | propyl]amino]ethyl]- |
| S42 | 1,2-Ethanediamine, N,N,N'-tris[3-(trimethoxysilyl)propyl]-(9Cl) |

### Example 6

The surface modified particles from Example 5 are further modified using the method as described in Example 2.

### Example 7

The method along the lines of Example 1 is expanded to include other modifying reagents of interest, which provide the resulting product with both an ionizable modifier and a hydrophobic modifier. Such modifying reagents include but are not limited to not limited to S43-S48 in Table 5. Because the modifying reagent includes a hydrophobic modifier, the steps in Example 1, wherein a hydrophobic modifying reagent (Octadecyltrichlorosilane (tC₁₈) is added to the particles/toluene slurry, refluxed and cooled can be dispensed with. In other embodiments, the steps in Example 1, wherein a hydrophobic modifying reagent (Octadecyltrichlorosilane (tC₁₈) is added to the particles/toluene slurry, refluxed and cooled are conducted.

TABLE 5

| Designation | Silane Name |
|---|---|
| S43 | 1-Octadecanamine, N-[3-(trimethoxysilyl)propyl]- |
| S44 | 1-Docosanamine, N-[3-(trimethoxysilyl)propyl]- |
| S45 | 1,3-Propanediamine, N-octadecyl-N'-[3-(trimethoxysilyl)propyl]- |
| S46 | 3-Octadecanamine, 1-(trimethoxysilyl)- |
| S47 | 1-Hexadecanamine, N,N-bis[3-(trimethoxysilyl)propyl]- |
| S48 | 3,8-Dioxa-4,7-disiladecan-5-amine, 4,4,7,7-tetraethoxy-N-hexadecyl-N-propyl |

### Example 8

The surface modified particles from Example 8 are further modified using the method as described in Example 2.

### Example 9

Anion Exchange/Reversed Phase Liquid Chromatography (RPLC) of Sialylated Glycans. Separations of sialylated glycans have been achieved with a material in accordance with the present disclosure, and they have been found to exhibit remarkably high resolution. An exemplary embodiment is provided in which RapiFluor-MS labeled glycans from bovine fetuin (Sigma) have been separated with a dual ammonium formate/acetonitrile gradient using a column packed with 1.7 μm bridged ethylene organosilica 100 Å fully porous particles modified with a bis-silyl tertiary amine containing ionizable modifier along with a trifunctionally bonded C₁₈ as described above.

A chromatogram from this separation is displayed in FIG. 1. Glycan assignments have been made using Oxford notation. For example, A3G3S3 denotes a glycan comprised of a triantennary core (A3) that is modified with three galactose residues (G3) and three sialic acid residues (S3). Some annotations include a parenthesis marking with NGNA to denote where sialic acid residues are present in the form of N-glycol versus N-acetyl moieties. In this, it can be seen that it was possible to resolve isomer and glycan charge heterogeneity from bovine fetuin, as is exemplified by the numerous, baseline resolved peaks and their annotations. In turn, these results suggest there to be great promise in this disclosure and its application to the structural characterization of sialylated glycoproteins, including recombinant protein therapeutics ranging from blood factors to enzyme replacement therapies, which are typically designed to exhibit high levels of sialylation in order to extend circulation half-life or affect inflammatory responses.

TABLE 6
Conditions for Anion Exchange
RPLC with Fluorescence and MS Detection

| | ACQUITY UPLC I-Class |
|---|---|
| System: | and Xevo G2-S QTof |
| Data Acquisition | UNIFI |
| and Analysis: | |
| Temperature: | 60° C. |
| Seal Wash: | 10% HPLC grade Methanol/90% HPLC |
| | grade water v/v (Seal Wash interval set |
| | to 5 min) |
| Sample Manager | HPLC grade water |
| Wash: | |
| Mobile Phase A1 | Water |
| and A2: | |
| Mobile Phase B1 | 100 mM formic acid/100 mM ammonium |
| and B2: | formate in 40:60 water/acetonitrile |
| Flow Rate: | 0.40 mL/min |
| Sample Temp. | 10° C. |
| Sample: | RapiFluor-MS labeled N-glycans from |
| | bovine fetuin (glycans from 0.17 μg of |
| | fetuin/μL) |
| Blank: | Milli-Q water |
| Injection Volume: | 3 μL |
| Fluorescence | Ex 265 nm/Em 425 nm |
| Detection: | |
| Mode: | ESI+ sensitivity |
| Capillary voltage: | 3.0 kV |
| Sampling Cone | 30 V |
| voltage: | |
| Source temp.: | 100° C. |
| Desolvation temp.: | 300° C. |
| Cone gas flow: | 50 L/h |
| Desolvation gas | 800 L/h |
| flow: | |

### Example 10

Anion Exchange RPLC of Phosphorylated Glycans. Glycans released from recombinant human β-glucuronidase (Novus Biologics, 6144-GH) have also been prepared, labeled with RapiFluor-MS® and subjected to chromatographic analysis using a column packed with 1.7 μm bridged ethylene organosilica 100 Å fully porous particles modified with a bis-silyl tertiary amine containing ionizable modifier along with a trifunctionally bonded C₁₈ as described above. Glycans can be found in this type of sample that contain mannose-6-phosphate (M6P) residues. In the case of enzyme replacement therapies that address lysosomal storage disorders, the amount of this residue and the relative amounts of the corresponding glycan structures are critically important. A multitude of enzymes have been brought to market for patient treatments, including recombinant glucuronidase, galactosidase, glucosidase, heparin sulfatase, and each of these must be post-translationally modified with M6P in order for cellular uptake to be properly facilitated. Accordingly, it is important for there to be robust assays for the detection and quantitation of M6P containing glycans.

A chromatogram from this separation is displayed in FIG. 2. Glycan assignments have been made according to their compositional information (Hex=hexose, HexNAc=N-acetyl hexosamine). M5, M6, and M9 correspond to high mannose glycans. FA1G1 is assigned based on Oxford notation. Importantly, glycans containing a phospho group are denoted with a “P”; singly phosphorylated glycans are assigned “-P” and doubly phosphorylated are assigned “-2P”.

With these analytical results, enhanced resolution is achieved on top of charge-based speciation of the glycan species. That is, the N-glycans are seen to elute into distinct pools of uncharged, singly charged, doubly charged, and triply charged species. Within each of the chromatographic regions, glycan heterogeneity is further elucidated by their isomerization and individual composition of charge bearing residues, e.g., one phosphorylated residue and two sialylated residues. There is consequently an abundance of information produced in a short amount of time and each species can be detected via an optical detector or with online mass spectrometric detection.

1. A chromatographic material that comprises a chromatographic surface wherein the chromatographic surface comprises a hydrophobic modifier and an ionizable modifier comprising one or more anion exchange moieties, which are positively charged when ionized.

2. The chromatographic material of claim 1, wherein the high purity chromatographic material is hydrolytically stable over a pH range of about 3 to about 10.

3. The chromatographic material of claim 1, wherein the chromatographic material is an inorganic material, a hybrid organic/inorganic material, an inorganic material with a hybrid surface layer, a hybrid material with an inorganic surface layer, or a hybrid material with a different hybrid surface layer.

4. (canceled)

5. The chromatographic material of claim 1, wherein the high purity chromatographic material comprises a hybrid organic/inorganic material that comprise ≡Si—(CH₂)ₙ—Si≡ moieties and/or (CH₂)ₘCH₃ moieties, where n is an integer equal to 1, 2, 3, or 4 and m is an integer equal to 0, 1, 2 or 3.

6. The chromatographic material of claim 1, wherein the chromatographic material may be formed by hydrolytically condensing (a) one or more silane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, although at most three of Z₁, Z₂, Z₃ and Z₄ can be C₁-C₄ alkyl, and/or (b) one or more compounds of the formula Si—Z₁Z₂Z₃—R—SiZ₄Z₅Z₆, where Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl, and where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, and where R is an organic radical.

7. (canceled)

8. The chromatographic material of claim 1, wherein the hydrophobic modifier comprises a C₄-C₃₀ aliphatic moiety, C₄-C₃₀ aromatic moiety, a phenylalkyl moiety, or a fluoro-aromatic moiety.

9. (canceled)

10. The chromatographic material of claim 1, wherein the hydrophobic modifier is present in a surface concentration ranging from 0.1 to 5 micromoles per square meter.

11. The chromatographic material of claim 1, wherein the ionizable modifier comprises an anion exchange moiety having a pKa ranging from 4 to 13.

12. The chromatographic material of claim 1, wherein the ionizable modifier comprises an anion exchange moiety selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety.

13. The chromatographic material of claim 11, wherein the anion exchange moiety is attached to the chromatographic surface by six or more siloxy bonds.

14. The chromatographic material of claim 1, wherein the ionizable modifier comprises an anion exchange moiety selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety that bridges two or more siloxy groups, wherein each siloxy group is attached to the chromatographic surface by three siloxy bonds.

15. The chromatographic material of claim 1, wherein a molar ratio of hydrophobic modifier:ionizable modifier is from about 2:1 to about 100:1.

16. The chromatographic material of claim 1, wherein a surface concentration of the ionizable modifier is from about 0.01 μmol/m² to about 1.0 μmol/m².

17. The chromatographic material of claim 1, wherein the chromatographic surface is derivatized by reacting the chromatographic material with reactive hydrophobic modifying reagent that comprises (a) a hydrophobic moiety and (b) one or more reactive silane groups.

18. The chromatographic material of claim 17, wherein the ionizable modifying reagent is of the formula M(SiZ₁Z₂Z₃)ₙ where n=1, 2, 3, or more, M designates a hydrophobic moiety, and Z₁, Z₂ and Z₃ are independently selected from Cl, Br, I, C₁-C₄ alkoxy and C₁-C₄ alkylamino.

19. (canceled)

20. (canceled)

21. The chromatographic material of claim 1, wherein the chromatographic surface is derivatized by reacting the chromatographic material with an ionizable modifying reagent that comprises (a) one or more moieties selected from an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety and (b) two or more reactive silane groups.

22. (canceled)

23. The chromatographic material of claim 1, wherein the chromatographic surface is derivatized by reacting the chromatographic material with an ionizable modifying reagent of the formula A(SiZ₁Z₂Z₃)ₙ where n=1, 2, 3, 4 or more, where A designates an amine-containing moiety, a guanidine-containing moiety, an amidine-containing moiety, a pyridyl-containing moiety, an imidazolyl-containing moiety, a carbazolyl-containing moiety, an isocyanurate-containing moiety and/or a semicarbazidyl-containing moiety, where Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl, and where when n=2 or more, each of the —SiZ₁Z₂Z₃ groups may be the same as each other, or each of the SiZ₁Z₂Z₃ groups may be different from one another.

24. (canceled)

25. (canceled)

26. (canceled)

27. The chromatographic material of claim 17, wherein the chromatographic surface is further derivatized by reacting the chromatographic material with a silane capping reagent.

28. The chromatographic material of claim 27, wherein the silane capping reagent is a silane compounds of the formula SiZ₁Z₂Z₃Z₄, where Z₁ is selected from Cl, Br, I, C₁-C₄ alkoxy and C₁-C₄ alkylamino and wherein Z₂, Z₃ Z₄ are independently selected from C₁-C₂ alkyl.

29. The chromatographic material of claim 1, wherein the chromatographic material is in the form of a particle, a monolith, a superficially porous material, a superficially porous particle, a superficially porous monolith, or a superficially porous layer for open tubular chromatography.

30. The chromatographic material of claim 1, wherein the high purity chromatographic material has a pore diameter of about 20 to 1500 Å.

31. (canceled)

32. (canceled)

33. A chromatographic separation device that contains chromatographic material of claim 1.

34. (canceled)

35. (canceled)

36. (canceled)

37. (canceled)

38. A method for mixed mode, anion exchange reversed phase liquid chromatography comprising: (a) loading a sample comprising a plurality of acidic analytes onto a chromatographic separation device comprising a chromatographic material in accordance with claim 1 such that the acidic analytes are adsorbed onto the high purity chromatographic material and (b) eluting the adsorbed acidic analytes from the high purity chromatographic material with a mobile phase comprising water, organic solvent, and an organic acid salt thereby separating the acidic analytes, wherein eluting the acidic analytes from the chromatography material with the mobile phase comprises a course of elution in which a pH of the mobile phase is altered over time, an ionic strength of the mobile phase is altered over time, and a concentration of the organic solvent is altered over time.

39-59. (canceled)
